(19) United States
(12) Patent Application Publication
(10) Pub. No.: US 2025/0268433 A1
(43) Pub. Date: Aug. 28, 2025

(54) Toliet Bowl Siphon Jet Cleaning Device

(71) Applicants: Neil Hoover, New Stanton, PA (US); Jessica Hoover, New Stanton, PA (US)

(72) Inventors: Neil Hoover, New Stanton, PA (US); Jessica Hoover, New Stanton, PA (US)

(21) Appl. No.: 18/589,104

(22) Filed: Feb. 27, 2024

(51) Int. Cl. A47K 11/10; A46B 9/02

(52) U.S. Cl. CPC A47K 11/10; A46B 9/028; A46B 2200/304

(57) ABSTRACT

A toilet bowl siphon jet cleaning device generally includes an elongated handle, a head portion, a light arrangement, and cleaning bristles. The light arrangement is positioned in the elongated handle and/or the head portion and designed to illuminate at least a portion thereof and surrounding external areas. The cleaning bristles are positioned parallel to one another and compact together to be inserted into a siphon jet to permit a user to clean residues and buildup of waste, biological material, or mineral deposits in the siphon jet to minimize blockages and maximize flow of water through the siphon jet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to toilet brushes and toilet cleaning devices and more particularly pertains to a new toilet bowl siphon jet cleaning device for cleaning a siphon jet to clean residues and buildup of waste, biological material, or mineral deposits in the siphon jet to minimize blockages and maximize flow of water through the siphon jet. Toilet siphon jets are critical for the proper flow and flushing of a toilet. Over time, those siphon jets can become clogged or obstructed with organic material and mineral deposits. The siphon jets are difficult to reach and clean with regular toilet brushes, and it is difficult to see if there is buildup.

### (2) Description of Related Art including information disclosed under 37 CFR 1.97 and 1.98.

The prior art relates to toilet brushes and toilet cleaning devices. The prior art, as best understood, does not disclose a toilet bowl siphon jet cleaning device with bristles that can be inserted straight into a siphon jet, and also including light-emitting diode (LED) lights that can illuminate the siphon jet area.

### BRIEF SUMMARY OF THE INVENTION

An embodiment of the disclosure meets the needs presented above in a toilet bowl siphon jet cleaning device generally comprising an elongated handle, a head portion, a light arrangement, and cleaning bristles. The elongated handle is designed to be held by a user. The head portion is connected to one end of the elongated handle and extends transverse to the elongated handle. The light arrangement is positioned in at least one of the elongated handle and the head portion and designed to illuminate at least a portion thereof and surrounding external areas. The head portion is substantially shorter than the elongated handle to permit insertion into a mouth of a trap in the bottom of a toilet bowl adjacent a siphon jet. The head portion includes a rounded end portion. The cleaning bristles are positioned to project out of the center of the rounded end portion essentially coaxially with respect to the head portion. The cleaning bristles are positioned parallel to one another and compact together to form a generally cylindrical shape with a round outer profile and a flat end profile designed to be inserted into a siphon jet to permit a user to clean residues and buildup of waste, biological material, or mineral deposits in the siphon jet to minimize blockages and maximize flow of water through the siphon jet.

This design allows a user to get the cleaning bristles up into the siphon jet. In addition, since the bristles are oriented coaxially and parallel to one another, and thus essentially parallel to the surfaces of the siphon jet, the bristles are less likely to scratch or abrade the surfaces of the siphon jet. Such scratches or abrasions in the visible bowl are undesirable for aesthetic reasons, but, in the case of the siphon jet, such scratches and abrasions are undesirable for practical reasons because the scratches and abrasions provide places for organic and inorganic material to lodge and cause buildup.

In accordance with at least one possible embodiment, the light arrangement includes LED lights that are solar-rechargeable and a solar light receiving panel disposed in at least one of said elongated handle and said head portion and operatively connected to said LED lights. This design allows a user to have illumination in darker areas without the need for batteries.

In accordance with at least one possible embodiment, the LED lights are positioned in the head portion. The cleaning bristles comprise transparent filaments designed and positioned to be illuminated by the LED lights. This design allows the user to illuminate the siphon jet area, which is hard to see and usually underwater.

In accordance with at least one possible embodiment, the cleaning bristles comprise a sufficient number of cleaning bristles to define a generally cylindrical shape that essentially matches the diameter of a toilet siphon jet. This design allows the use to fully clean the siphon jet by both brushing and pushing out organic and inorganic materials.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a toilet bowl siphon jet cleaning device according to an embodiment of the disclosure.

FIG. 2 is a front view of an embodiment of the disclosure.

FIG. 3 is a close-up view of a portion of an embodiment of the disclosure.

FIG. 4 is a side view of an embodiment of the disclosure in use.

FIG. 5 is a front perspective view of an embodiment of the disclosure.

FIG. 6 is a front perspective view of an embodiment of the disclosure.

### DETAILED DESCRIPTION OF THE INVENTION

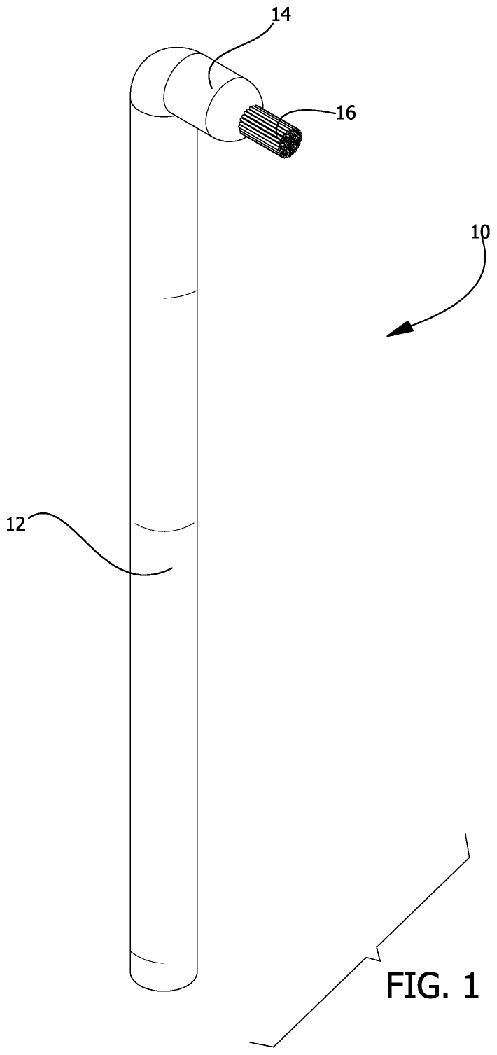

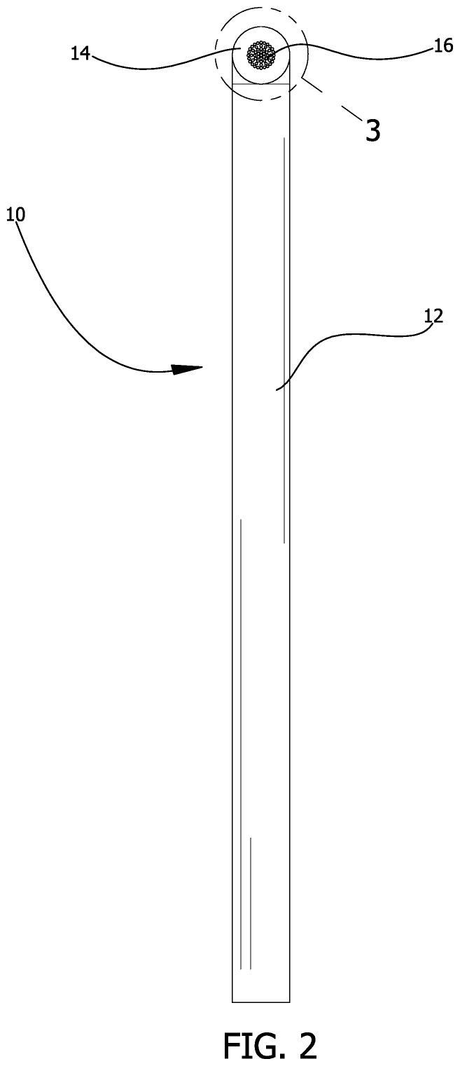

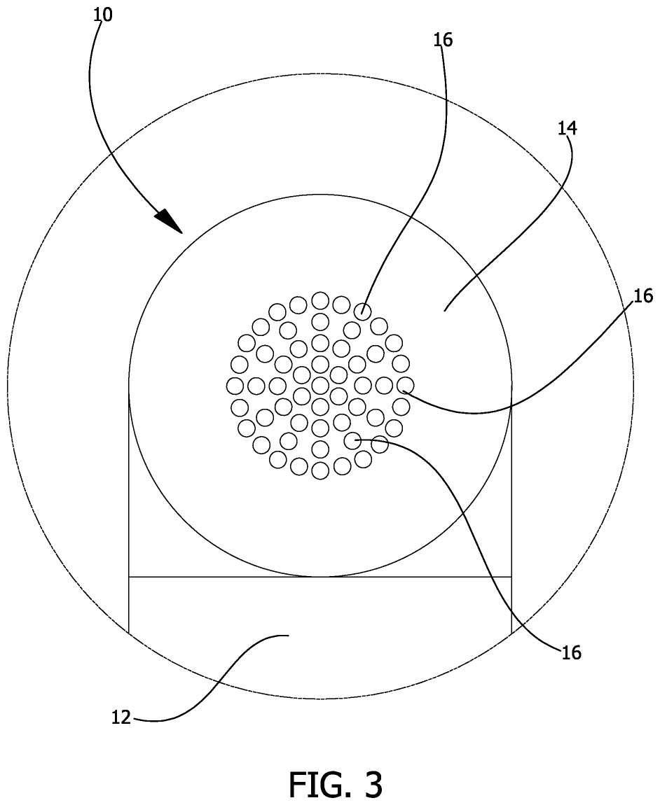

With reference now to the drawings, and in particular to FIGS. 1 through 6 thereof, a new toilet bowl siphon jet cleaning device embodying the principles and concepts of an embodiment of the disclosure and generally designated by the reference numeral 10 will be described.

As best illustrated in FIGS. 1 through 6, the toilet bowl siphon jet cleaning device 10 generally comprises an elongated handle 12, a head portion 14, a light arrangement, and cleaning bristles 16. The elongated handle 12 is designed to be held by a user. The head portion 14 is connected to one end of the elongated handle 12 and extends transverse to the elongated handle 12. The light arrangement is positioned in at least one of the elongated handle 12 and the head portion 14 and designed to illuminate at least a portion thereof and surrounding external areas. The head portion 14 is substantially shorter than the elongated handle 12 to permit insertion into a mouth 18 of a trap 20 in the bottom of a toilet bowl 22 adjacent a siphon jet 24. The head portion 14 includes a rounded end portion. The cleaning bristles 16 are positioned to project out of the center of the rounded end portion essentially coaxially with respect to the head portion 14. The cleaning bristles 16 are positioned parallel to one another and compact together to form a generally cylindrical shape with a round outer profile and a flat end profile designed to be inserted into a siphon jet 24 to permit a user to clean residues and buildup of waste, biological material, or mineral deposits in the siphon jet 24 to minimize blockages and maximize flow of water through the siphon jet 24.

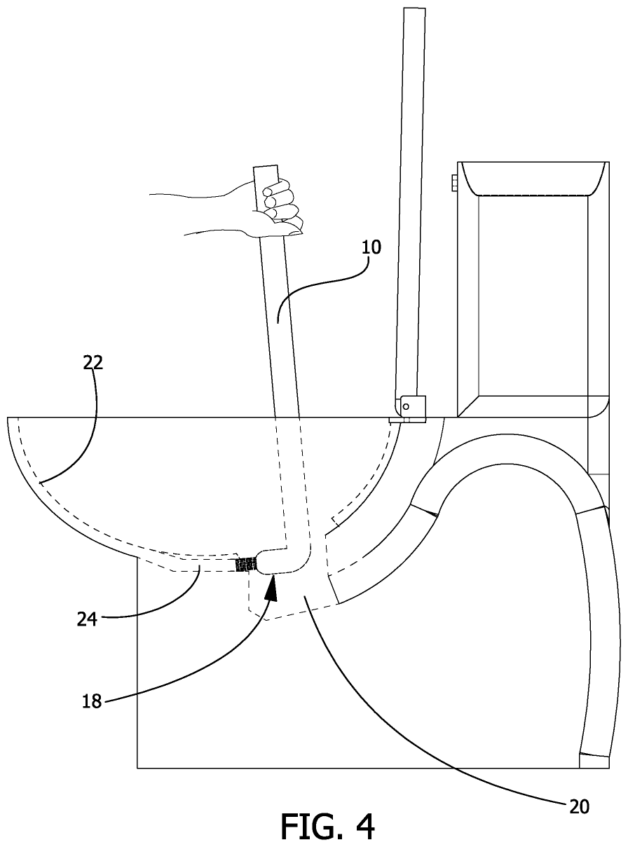

In accordance with at least one possible embodiment, the cleaning bristles 16 comprise a sufficient number of cleaning bristles 16 to define a generally cylindrical shape that essentially matches the diameter of the siphon jet 24. FIG. 4 shows a user using the toilet bowl siphon jet cleaning device 10 to clean the siphon jet 24.

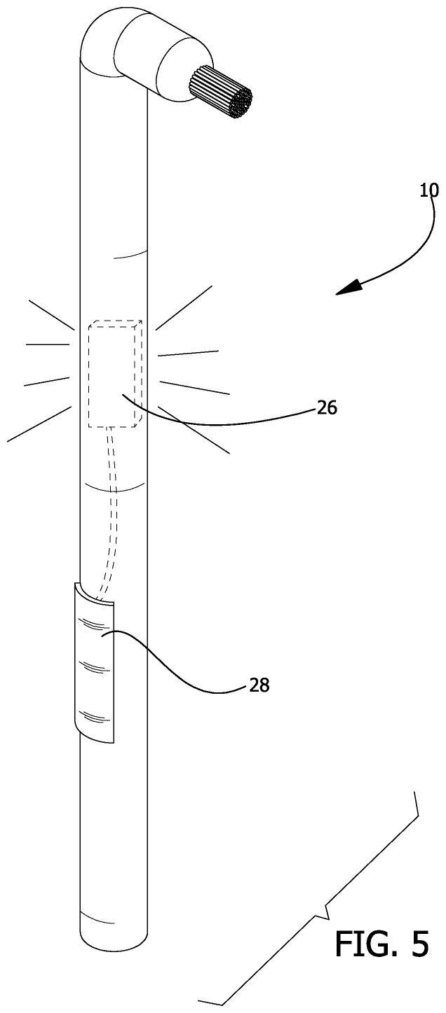

In accordance with at least one possible embodiment, the light arrangement includes LED lights 26 that are solar-rechargeable. The light arrangement includes a solar light receiving panel 28 positioned in at least one of the elongated handle 12 and the head portion 14 and operatively connected to the light arrangement. FIG. 5 shows one possible embodiment in which the solar light receiving panel 28 is located in the elongated handle 12 and operatively connected to LED lights 26 in the elongated handle 12. Light can shine through the elongated handle 12 via openings or a transparent body in a known manner.

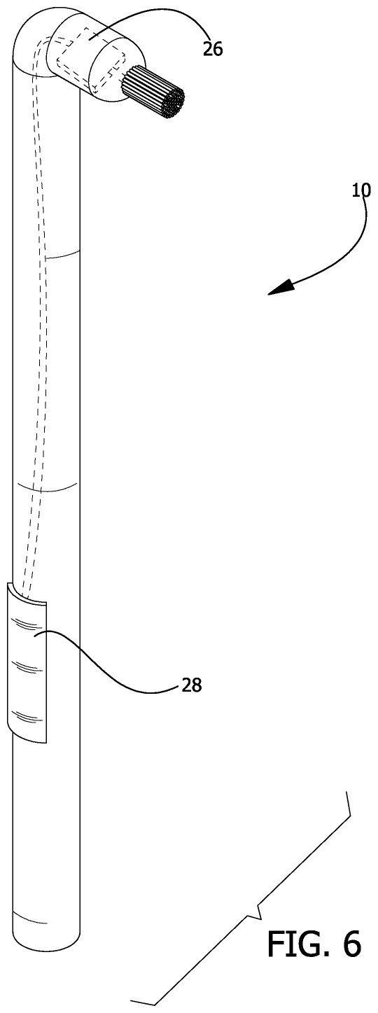

In accordance with at least one possible embodiment, the LED lights 26 are positioned in the head portion 14. The cleaning bristles 16 comprise transparent filaments designed and positioned to be illuminated by the LED lights 26. FIG. 6 shows an example of such an embodiment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A toilet bowl siphon jet cleaning device comprising:
an elongated handle configured to be held by a user;
a head portion being connected to one end of said elongated handle and extending transverse to said elongated handle;
a light arrangement being disposed in at least one of said elongated handle and said head portion and configured to illuminate at least a portion thereof and surrounding external areas;
said head portion being substantially shorter than said elongated handle to permit insertion into a mouth of a trap in the bottom of a toilet bowl adjacent a siphon jet;
said head portion comprising a rounded end portion;
cleaning bristles being disposed to project out of the center of said rounded end portion essentially coaxially with respect to said head portion; and
said cleaning bristles being disposed parallel to one another and compact together to form a generally cylindrical shape with a round outer profile and a flat end profile configured to be inserted into a siphon jet to permit a user to clean residues and buildup of waste, biological material, or mineral deposits in the siphon jet to minimize blockages and maximize flow of water through the siphon jet.

2. The toilet bowl siphon jet cleaning device of claim 1, wherein said light arrangement comprises LED lights that are solar-rechargeable and a solar light receiving panel disposed in at least one of said elongated handle and said head portion and operatively connected to said LED lights.

3. The toilet bowl siphon jet cleaning device of claim 2, wherein:
said LED lights are disposed in said head portion; and
said cleaning bristles comprise transparent filaments configured and disposed to be illuminated by said LED lights.

4. The toilet bowl siphon jet cleaning device of claim 3, wherein said cleaning bristles comprise a sufficient number of cleaning bristles to define a generally cylindrical shape that essentially matches the diameter of a siphon jet.

5. The toilet bowl siphon jet cleaning device of claim 1, wherein:
said light arrangement comprises LED lights disposed in said head portion; and
said cleaning bristles comprise transparent filaments configured and disposed to be illuminated by said LED lights.

6. The toilet bowl siphon jet cleaning device of claim 1, wherein said cleaning bristles comprise a sufficient number of cleaning bristles to define a generally cylindrical shape that essentially matches the diameter of a siphon jet.
